(19) United States
(12) Patent Application Publication
(10) Pub. No.: US 2024/0187094 A1
(43) Pub. Date: Jun. 6, 2024

(54) BEAM TRANSMISSION DEVICE AND BEAM TRANSMISSION METHOD

(71) Applicant: NIPPON TELEGRAPH AND TELEPHONE CORPORATION, Tokyo (JP)

(72) Inventors: Naotaka SHIBATA, Musashino-shi, Tokyo (JP); Takeshi IMAI, Musashino-shi, Tokyo (JP); Rintaro HARADA, Musashino-shi, Tokyo (JP); Shin KANEKO, Musashino-shi, Tokyo (JP)

(73) Assignee: NIPPON TELEGRAPH AND TELEPHONE CORPORATION, Tokyo (JP)

(21) Appl. No.: 18/285,496

(22) PCT Filed: Apr. 5, 2021
(86) PCT No.: PCT/JP2021/014511

§ 371 Date: Oct. 4, 2023

(51) Int. Cl. H04B 10/112; H04B 10/516; H04L 1/00

(52) U.S. Cl. CPC H04B 10/112; H04B 10/5161; H04L 1/0061

(57) ABSTRACT

A beam transmission device transmits a directional beam toward a beam reception device in a wireless communication system. The main signal generation unit generates a main signal. A control signal generation unit periodically generates a control signal related to maintaining communication with the beam reception device. A signal multiplexing unit multiplexes the main signal and the control signal. A divergence angle adjustment unit sets a target divergence angle to a first divergence angle in a period in which the control signal is not included in the multiplexed signal, and sets the target divergence angle to a second divergence angle larger than the first divergence angle in a period in which the control signal is included in the multiplexed signal. A beam control unit changes a divergence angle of the beam modulated by the multiplexed signal to the target divergence angle.

### TECHNICAL FIELD

The present invention relates to a beam transmission device and a beam transmission method for transmitting a directional beam toward a beam reception device in a wireless communication system.

### BACKGROUND ART

Free space optical communication (FSO) in which a beam having strong directivity is used to transmit and receive data has been studied. In an optical wireless communication system, a beam having directivity is transmitted from a beam transmission unit provided in a transmission side device to a beam reception unit provided in a reception side device. In a case where the beam reception unit is mounted on a mobile object such as a train or an aircraft, in order to maintain communication, it is necessary to perform beam tracking for changing a direction of the beam transmitted from the beam transmission unit to a direction of the beam reception unit.

Non Patent Literature 1 discloses an optical wireless communication device capable of performing beam tracking to a moving beam reception unit.

### CITATION LIST

### Non Patent Literature

Non Patent Literature 1: Rintaro Harada, Naotaka Shibata, Shin Kaneko, Jun Terada, “A Directivity Control Scheme for FSO Communications with Mobile Object toward 6G”, The Institute of Electronics, Information and Communication Engineers, 2020 Communication Society Conference, B-8-7, Sep. 1, 2020

### SUMMARY OF INVENTION

### Technical Problem

Meanwhile, an output of the beam transmission unit is not completely parallel, and expands with a transmission distance by a minute divergence angle θ. In order to keep signal power high, it is necessary to reduce the divergence angle as much as possible. However, since a beam becomes narrower as the divergence angle is smaller, the beam becomes weak against an optical axis deviation due to fluctuation of a position of the transmission/reception unit.

In the optical space communication, unless a dedicated communication device is installed, control information related to communication maintenance such as a command to a reception side device and a device information notification is transmitted by using a part of a main signal. That is, there is a possibility that the main signal and the control information are lost due to a minute deviation of the optical axis.

Loss of the main signal can be compensated by performing retransmission. However, in a case where the control information is lost, there is a possibility that communication itself cannot be maintained. Therefore, it is necessary to avoid loss of the control information more than the main signal. In addition, when the divergence angle is widened in order to easily obtain the control information, the optical axis deviation due to the variation in the position of the transmission/reception unit is strong, but the signal power is reduced. Therefore, there is a problem that main signal power is lowered.

The present invention has been made to solve the above-described problems, and an object of the present invention is to provide a beam transmission device and a beam transmission method capable of avoiding loss of a control signal even if an axis deviation occurs without impairing reception power of a main signal.

### Solution to Problem

A first aspect relates to a beam transmission device that transmits a directional beam toward a beam reception device in a wireless communication system.

The beam transmission device includes a main signal generation unit, a control signal generation unit, a signal multiplexing unit, a divergence angle adjustment unit, and a beam control unit.

The main signal generation unit generates a main signal.

The control signal generation unit periodically generates a control signal related to maintaining communication with the beam reception device.

The signal multiplexing unit multiplexes the main signal and the control signal.

The divergence angle adjustment unit sets a target divergence angle to a first divergence angle in a period in which the control signal is not included in the multiplexed signal, and sets the target divergence angle to a second divergence angle larger than the first divergence angle in a period in which the control signal is included in the multiplexed signal.

The beam control unit changes a divergence angle of the beam modulated by the multiplexed signal to the target divergence angle.

A second aspect relates to a beam transmission method for transmitting a directional beam toward a beam reception device in a wireless communication system.

The beam transmission method includes a main signal generation step, a control signal generation step, a signal multiplexing step, a divergence angle adjustment step, and a beam control step.

In the main signal generation step, a main signal is generated.

In the control signal generation step, a control signal related to maintaining communication with the beam reception device is periodically generated.

In the signal multiplexing step, the main signal and the control signal are multiplexed.

In the divergence angle adjustment step, a target divergence angle is set to a first divergence angle in a period in which the control signal is not included in the multiplexed signal, and the target divergence angle is set to a second divergence angle larger than the first divergence angle in a period in which the control signal is included in the multiplexed signal.

In the beam control step, a divergence angle of the beam modulated by the multiplexed signal is changed to the target divergence angle.

### Advantageous Effects of Invention

A beam transmission device according to the present invention performs control to make a divergence angle of a transmission beam of a control signal related to communication maintenance larger than a divergence angle of a transmission beam of a main signal. Therefore, according to the present invention, loss of the control signal can be avoided when an axis deviation occurs without impairing reception power of the main signal.

### BRIEF DESCRIPTION OF DRAWINGS

FIG. 1 is a diagram illustrating a wireless communication system according to a first embodiment of the present invention.

FIG. 2 is a block diagram illustrating an outline of functions of a beam transmission device according to the first embodiment of the present invention.

FIG. 3 is a diagram for describing control of a beam divergence angle according to the first embodiment of the present invention.

FIG. 4 is a block diagram illustrating an outline of functions of a beam transmission device according to a second embodiment of the present invention.

FIG. 5 is a diagram illustrating a hardware configuration example of each unit of the beam transmission device.

### DESCRIPTION OF EMBODIMENTS

Hereinafter, embodiments of the present invention will be described in detail with reference to the drawings. However, in a case where the number, numerical quantity, quantity, range, or the like of each element is referred to in the embodiment shown below, the present invention is not limited to the numbers mentioned, except when explicitly stated or when the numbers are clearly specified in principle. In addition, the structures and the like described in the embodiments described below are not necessarily essential to the present invention unless otherwise specified or clearly specified in principle. Note that elements common in the drawings are denoted by the same reference numerals, and redundant description will be omitted.

### First Embodiment

### 1. Wireless Communication System

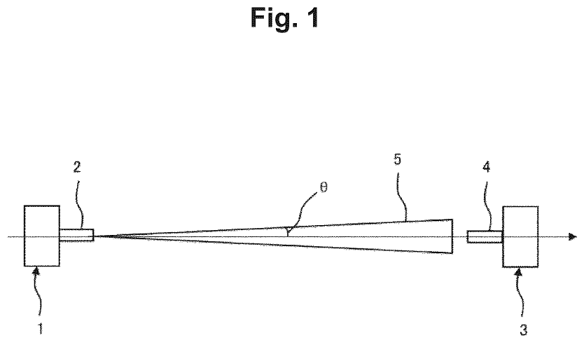

FIG. 1 is a diagram illustrating a wireless communication system according to a first embodiment. In the wireless communication system, a beam 5 having directivity is transmitted from a beam transmission unit 2 of a beam transmission device 1 toward a beam reception unit 4 of a beam reception device 3. As a result, data is transmitted and received between the beam transmission device 1 and the beam reception device 3.

The beam 5 is a free space optical communication (FSO) signal. The FSO signal is, for example, an optical signal having a very high frequency around 193 THz. By using the FSO signal, communication can be performed with a beam having very high directivity as compared with a wireless signal of a millimeter wave band (up to 300 GHz) or less. Note that the beam 5 transmitted by the beam transmission unit 2 is not limited to an optical signal such as the FSO signal, and may be a wireless signal.

### 2. Beam Transmission Device

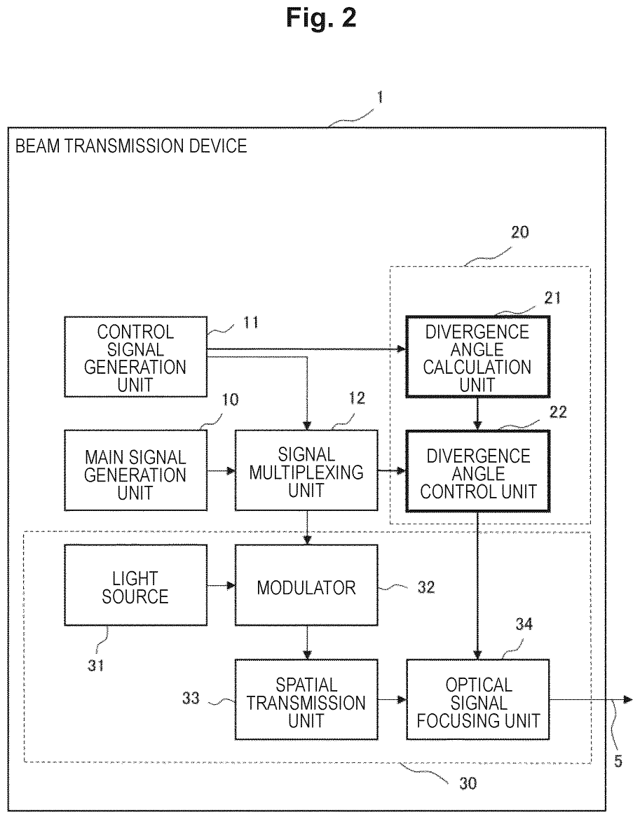

FIG. 2 is a block diagram illustrating an outline of functions of the beam transmission device 1 according to the first embodiment. The beam transmission device 1 includes a main signal generation unit 10, a control signal generation unit 11, a signal multiplexing unit 12, a divergence angle adjustment unit 20, and a beam control unit 30.

The main signal generation unit 10 generates a main signal by performing modulation processing related to the number of modulation levels and coding processing related to error correction coding on main information. The main information is, for example, user data, and is data not related to control for maintaining communication.

The control signal generation unit 11 periodically generates a control signal having reception power lower than that of the main signal by performing modulation processing related to the number of modulation levels and coding processing related to error correction coding on control information. The control information is data related to maintaining communication with the beam reception device 3, such as a command to the beam reception device 3 and a device information notification. Here, it is assumed that the main signal and the control signal are different from each other in number of modulation levels or coding rate of the error correction coding.

The signal multiplexing unit 12 multiplexes the main signal subjected to the modulation processing and the coding processing in the main signal generation unit 10 and the control signal subjected to the modulation processing and the coding processing in the control signal generation unit 11. The signal multiplexing unit 12 outputs a multiplexed signal to the beam control unit 30.

Here, control of a beam divergence angle in the beam transmission device 1 according to the first embodiment will be described. As described above, loss of the main signal can be compensated by performing retransmission. However, when the control information is lost, there is a possibility that communication itself cannot be maintained. Therefore, it is necessary to avoid loss of the control information more than the main signal.

Therefore, in the present embodiment, the beam transmission device 1 transmits the main signal and the control signal in a time division manner, and a divergence angle of a transmission beam of the control signal is made larger than a divergence angle of a transmission beam of the main signal.

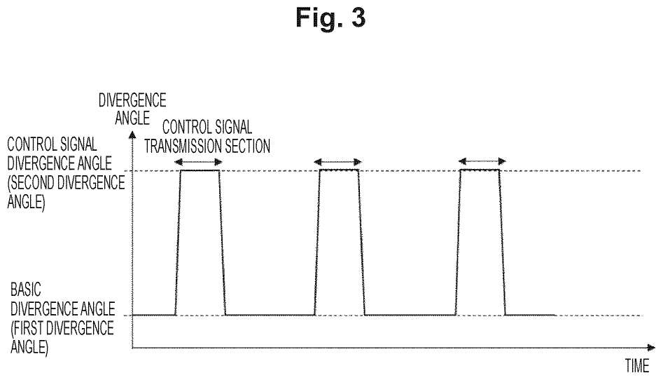

FIG. 3 is a diagram for describing control of a beam divergence angle. A basic divergence angle (first divergence angle) is a divergence angle set for transmitting the main signal with appropriate reception power. A control signal divergence angle (second divergence angle) is a divergence angle set only in a control signal transmission section. Since the second divergence angle is larger than the first divergence angle, reception power of the control signal is lower than that of the main signal. As illustrated in FIG. 3, the beam transmission device 1 expands the divergence angle only at the time of transmitting the control signal, so that the beam reception device 3 can easily receive the control signal without largely impairing the reception power of the main signal.

The description will be continued with reference to FIG. 2. The divergence angle adjustment unit 20 sets a target divergence angle to the first divergence angle in a period in which the control signal is not included in the multiplexed signal. The divergence angle adjustment unit 20 sets the target divergence angle to the second divergence angle larger than the first divergence angle in a period in which the control signal is included in the multiplexed signal. Here, the second divergence angle is calculated on the basis of the number of modulation levels and the coding rate of the error correction coding in the control signal generation unit 11 so that the reception power of the control signal does not fall below receivable lower limit power. Specifically, the divergence angle adjustment unit 20 includes a divergence angle calculation unit 21 and a divergence angle control unit 22.

The divergence angle calculation unit 21 calculates a divergence angle after control by the divergence angle control unit 22. First, the divergence angle calculation unit 21 calculates a decrease amount [dB] of required reception power of the control signal with respect to required reception power of the main signal on the basis of the number of modulation levels and the coding rate of the error correction coding of the control signal. The divergence angle calculation unit 21 calculates the second divergence angle on the basis of a predetermined relationship between a divergence angle and a reception power decrease amount within a range in which a decrease amount of the reception power accompanying the divergence angle increase is smaller than the calculated decrease amount of the required reception power. The relationship between the divergence angle and the reception power decrease amount may be determined by a theoretical formula or may be determined by a correspondence table based on actual measurement or simulation.

The divergence angle control unit 22 extracts a timing at which the control signal is transmitted from the signal multiplexing unit 12, and sets the target divergence angle to the second divergence angle within a range larger than the first divergence angle at the time of transmitting the main signal and satisfying the required reception power of the control signal at the timing. The divergence angle control unit 22 outputs an actuator control amount corresponding to the target divergence angle to the beam control unit 30.

The beam control unit 30 changes the divergence angle of the beam modulated by the multiplexed signal to the target divergence angle. Specifically, the beam control unit 30 includes a light source 31, a modulator 32, a spatial transmission unit 33, and an optical signal focusing unit 34.

The light source 31 outputs an optical carrier wave. The modulator 32 modulates the optical carrier wave by the signal multiplexed by the signal multiplexing unit 12. The spatial transmission unit 33 emits an optical signal flowing through fiber into space.

The optical signal focusing unit 34 focuses light transmitted in the space. As an example, the optical signal focusing unit 34 includes a liquid lens and an actuator that changes a curvature radius of the liquid lens. In the liquid lens, a focal length changes due to a change in the curvature radius, and a divergence angle changes due to a change in the focal length. The optical signal focusing unit 34 electronically controls the curvature radius of the liquid lens on the basis of the actuator control amount from the divergence angle control unit 22.

As another example, the optical signal focusing unit 34 may include two convex lenses and a position adjustment motor attached to one of the convex lenses. The two convex lenses generate a focal length as a synthetic lens, and the focal length can be changed by adjusting an interval between the two convex lenses by the position adjustment motor. The optical signal focusing unit 34 controls the position adjustment motor on the basis of the actuator control amount from the divergence angle control unit 22.

As described above, according to the beam transmission device 1 of the first embodiment, the divergence angle of the transmission beam of the control signal related to the communication maintenance can be made larger than the divergence angle of the transmission beam of the main signal. Therefore, according to the present invention, even when an axis deviation occurs, loss of the control signal can be avoided without impairing the reception power of the main signal. In addition, since this effect can be obtained only by the control of the beam transmission device 1, it is not necessary to change a configuration to the beam reception device 3, and it is possible to use this effect together with various reception side configurations.

### Modification

Meanwhile, in the first embodiment described above, it is assumed that the control signal and the main signal are different in number of modulation levels or coding rate of the error correction coding, but the present invention is also applicable to a case where the control signal and the main signal are different in modulation rate. Note that the same applies to the second embodiment on this point.

### Second Embodiment

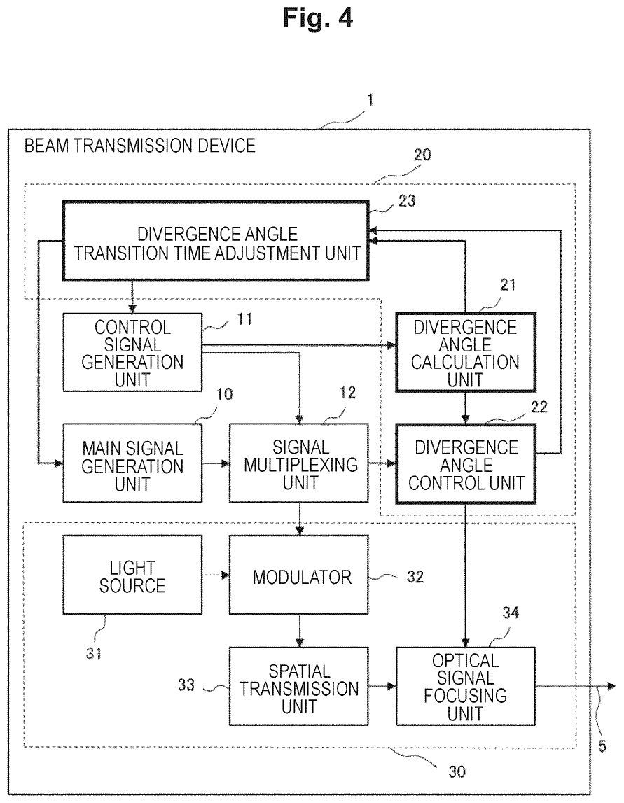

Next, a second embodiment of the present invention will be described with reference to FIG. 4.

FIG. 4 is a block diagram illustrating a configuration of the beam transmission device 1 according to the second embodiment. The beam transmission device 1 according to the second embodiment is similar to that of the first embodiment except that a divergence angle transition time adjustment unit 23 is added to the configuration of FIG. 2 described above. Hereinafter, description of the same processing contents as those of the first embodiment will be omitted or simplified.

According to the beam transmission device 1 of the first embodiment described above, the divergence angle of the transmission beam of the control signal can be made larger than the divergence angle of the transmission beam of the main signal. Incidentally, when the divergence angle for the main signal is changed to the divergence angle for the control signal or the divergence angle for the control signal is changed to the divergence angle for the main signal, there is a switching transition time of the divergence angle. When the divergence angle control unit 22 having a very short switching transition time is mounted, there is no problem even with the configuration of the first embodiment. However, there may be a case where the switching transition time is not short with respect to a main signal transmission speed due to performance of a product. In this case, the divergence angle increases during main signal transmission, and there is a possibility that the main signal cannot be demodulated/decoded by the beam reception device 3.

Therefore, in the second embodiment, the main signal can be demodulated even at a divergence angle larger than the divergence angle at the time of main signal transmission by adjusting the number of modulation levels or redundancy of error correction coding of the main signal, or both during divergence angle control, that is, during the switching transition time.

The divergence angle adjustment unit 20 includes the divergence angle transition time adjustment unit 23 in addition to the divergence angle calculation unit 21 and the divergence angle control unit 22 described above. The divergence angle transition time adjustment unit 23 changes at least one of the number of modulation levels and the redundancy of the error correction coding in the main signal generation unit 10 in the switching transition time between the first divergence angle and the second divergence angle.

For example, in a case where the switching transition time is T, the number of modulation levels of the main signal is 16 QAM, and the number of modulation levels of the control signal is BPSK, the number of modulation levels of the main signal may be always changed to BPSK in a section of T. Alternatively, when the time is divided into a plurality of times such as t1, t2, and t3 (t1+t2+t3=T) and transition is made from the divergence angle for the main signal to the divergence angle for the control signal, the number of levels may be gradually changed such that 16 QAM is set during t1 from the start of the transition, QPSK is set for the next t2, and BPSK is set for the last t3. The values of t1, t2, and t3 may be arbitrarily determined within a range that satisfies required reception power. Similarly, when transition is made from the divergence angle for the control signal to the divergence angle for the main signal, the time is divided into a plurality of times such as t1′, t2′, and t3′ (t1′+t2′+t3′=T), and BPSK may be set for the first t1′, QPSK may be set for the next t2′, and 16 QAM may be set for the last t3′.

In a case where the modulation scheme changes in this manner, the number of modulation levels or the redundancy of the error correction coding at the switching transition time may be included in the control signal and notified in the same manner as in a normal case. Alternatively, since there is no need to change the number of modulation levels or the redundancy of the error correction coding at each cycle, information thereof may be set in the beam reception device 3 in advance before operation.

As described above, according to the beam transmission device 1 of the second embodiment, the main signal can be demodulated even at the divergence angle larger than the divergence angle at the time of main signal transmission by adjusting at least one of the number of modulation levels and the redundancy of the error correction coding of the main signal at the switching transition time.

### Hardware Configuration

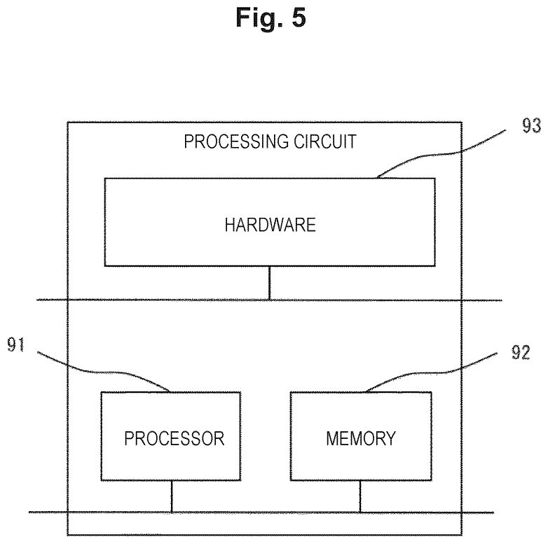

FIG. 5 is a conceptual diagram illustrating a hardware configuration example of a processing circuit included in each unit of the beam transmission device 1 according to the above-described embodiments. Each of the above-described functions is implemented by the processing circuit. As an aspect, the processing circuit includes at least one processor 91 and at least one memory 92. As another aspect, the processing circuit includes at least one dedicated hardware 93.

In a case where the processing circuit includes the processor 91 and the memory 92, each function is implemented by software, firmware, or a combination of software and firmware. At least one of the software and the firmware is described as a program. At least one of the software and the firmware is stored in the memory 92. The processor 91 implements each function by reading and executing the program stored in the memory 92.

In a case where the processing circuit includes the dedicated hardware 93, the processing circuit is, for example, a single circuit, a composite circuit, a programmed processor, or a combination thereof. Each function is implemented by the processing circuit.

Some or all of the functions of the beam transmission device 1 may be configured by hardware, or may be configured as a program executed by a processor. That is, the functions of the beam transmission device 1 can also be implemented by a computer and a program, and the program can be recorded on a recording medium or provided through a network.

Although the embodiments of the present invention have been described above, the present invention is not limited to the above-described embodiments, and various modifications can be made without departing from the gist of the present invention.

### REFERENCE SIGNS LIST

1 Beam transmission device
2 Beam transmission unit
3 Beam reception device
4 Beam reception unit
5 Beam
10 Main signal generation unit
11 Control signal generation unit
12 Signal multiplexing unit
20 Divergence angle adjustment unit
21 Divergence angle calculation unit
22 Divergence angle control unit
23 Divergence angle transition time adjustment unit
30 Beam control unit
31 Light source
32 Modulator
33 Spatial transmission unit
34 Optical signal focusing unit
θ Divergence angle

1. A beam transmission device that transmits a directional beam toward a beam reception device in a wireless communication system, the beam transmission device comprising:
main signal generation circuitry that generates a main signal;
control signal generation circuitry that periodically generates a control signal related to maintaining communication with the beam reception device;
signal multiplexing circuitry that multiplexes the main signal and the control signal;
divergence angle adjustment circuitry that sets a target divergence angle to a first divergence angle in a period in which the control signal is not included in the multiplexed signal, and sets the target divergence angle to a second divergence angle larger than the first divergence angle in a period in which the control signal is included in the multiplexed signal; and
beam control circuitry that changes a divergence angle of the beam modulated by the multiplexed signal to the target divergence angle.

2. The beam transmission device according to claim 1, wherein:
the control signal generation circuitry periodically generates the control signal having reception power lower than reception power of the main signal by performing modulation processing related to number of modulation levels and coding processing related to error correction coding on control information related to maintaining communication with the beam reception device, and
the second divergence angle is calculated based on the number of modulation levels and a coding rate of the error correction coding in the control signal generation circuitry such that the reception power of the control signal does not fall below receivable lower limit power.

3. The beam transmission device according to claim 1, wherein:
the main signal generation circuitry generates the main signal by performing modulation processing related to number of modulation levels and coding processing related to error correction coding on main information, and
the divergence angle adjustment circuitry further changes at least one of the number of modulation levels in the main signal generation circuitry and redundancy of the error correction coding in the main signal generation circuitry in a switching transition time during which the first divergence angle and the second divergence angle are switched.

4. The beam transmission device according to claim 1, wherein:
the beam is an optical signal.

5. A beam transmission method for transmitting a directional beam toward a beam reception device in a wireless communication system, the beam transmission method comprising:
generating a main signal;
periodically generating a control signal related to maintaining communication with the beam reception device;
multiplexing the main signal and the control signal;
setting a target divergence angle to a first divergence angle in a period in which the control signal is not included in the multiplexed signal, and setting the target divergence angle to a second divergence angle larger than the first divergence angle in a period in which the control signal is included in the multiplexed signal; and
changing a divergence angle of the beam modulated by the multiplexed signal to the target divergence angle.

6. The beam transmission method according to claim 5, wherein:
in the periodically generating, the control signal having reception power lower than reception power of the main signal is periodically generated by performing modulation processing related to number of modulation levels and coding processing related to error correction encoding on control information related to maintaining communication with the beam reception device, and
the second divergence angle is calculated based on the number of modulation levels and a coding rate of the error correction coding in the periodically generating so that the reception power of the control signal does not fall below receivable lower limit power.

7. The beam transmission method according to claim 5, wherein:
in the main signal generation step, the main signal is generated by performing modulation processing related to number of modulation levels and coding processing related to error correction coding on main information, and
in the divergence angle adjustment step, at least one of the number of modulation levels in the main signal generation step and redundancy of the error correction coding in the main signal generation step is further changed in a switching transition time during which the first divergence angle and the second divergence angle are switched.
